(19) United States
(12) Patent Application Publication
(10) Pub. No.: US 2020/0385532 A1
(43) Pub. Date: Dec. 10, 2020

(54) HYDROPHILIC AND OXYGEN PERMEABLE POLYMER MATERIAL

(71) Applicant: APEXLENS CO., LTD., Hsinchu City (TW)

(72) Inventors: Chien-Yen HUANG, Pingtung City (TW); Jia-Min CHIOU, New Taipei City (TW); Pai-Tsun CHEN, Taoyuan City (TW)

(73) Assignee: APEXLENS CO., LTD., HSINCHU CITY (TW)

(21) Appl. No.: 16/433,921

(22) Filed: Jun. 6, 2019

(51) Int. Cl. C08G 77/442; G02B 1/04

(52) U.S. Cl. CPC C08G 77/442; G02B 1/043

(57) ABSTRACT

Disclosed is a hydrophilic and oxygen permeable polymer material, including alicyclic Isocyanate, a grafted repeating unit with silicon-containing monomer, and a first hydrophilic moisturing grafted monomer. The grafted repeating unit has an average molecular weight less than or equal 5,000, and is in an amount of 20-60% based on the total weight of the hydrophilic and oxygen permeable polymer material. The first hydrophilic moisturing grafted monomer is in an amount of 1-40% based on the total weight of the hydrophilic and oxygen permeable polymer material.

### BACKGROUND OF THE INVENTION

### 1. Field of the Invention

The present invention generally relates to a hydrophilic polymer material, and more specifically to a hydrophilic polymer material with high oxygen permeability having alicyclic Isocyanate, a grafted repeating unit with silicon-containing monomer, and a first hydrophilic moisturing grafted monomer for manufacturing soft contact lens to protect eyes from dry environment.

### 2. The Prior Arts

Recently, contact lenses have become more popular due to easy use and high reliability, but users should avoid wearing the contact lenses too long because corneas do not acquire sufficient oxygen. Thus, one of the key features of the contact lenses is high oxygen permeability.

In the prior arts, some oxygen permeable materials like silicone hydrogel have been developed for the contact lenses, which may prevent irritation due to cornea hypoxia even after a prolonged wearing of the contact lenses.

However, one of the shortcomings in the prior arts is that its optical stability is not sufficient and chemical endurance is weak. As a result, the contact lenses become risky and its transparency is degraded. Another shortcoming is that weather, abrasion and hydrolysis endurance is also poor, and the contact lenses are not suitably worn for a prolonged period of time.

Therefore, it is greatly needed to provide a new hydrophilic polymer material high oxygen permeability for contact lens to protect eyes from adverse environment, thereby overcoming the above problems in the prior arts.

### SUMMARY OF THE INVENTION

The primary object of the present invention is to provide a hydrophilic and oxygen permeable polymer material having a structure presented by formula A-(B)_{b}-C, wherein A is alicyclic Isocyanate, B is a silicon-containing monomer modified by grafting as a repeating unit, b is an integer of 1-30, (B)_{b} has an average molecular weight less than or equal 5,000, and is in an amount of 20-60% based on the total weight of the hydrophilic and oxygen permeable polymer material, C is a first hydrophilic moisturing grafted monomer and in an amount of 1-40% based on the total weight of the hydrophilic and oxygen permeable polymer material.

Specifically, the first hydrophilic moisturing grafted monomer comprises at least one of Allyl alcohol, 2-Methyl-2-propen-1-ol, 2-Allylethyl alcohol, 2-(Dimethylamino)ethyl methacrylate, 2-(Dimethylamino)ethyl acrylate, 4-Penten-2-ol, N-[3-(Dimethylamino)propyl]methac Rylamide, Hydroxypropyl methacrylate, Poly(propylene glycol) methacrylate, 3-Methyl-2-buten-1-ol, rans,trans-2,4-Hexadien-1-ol, 2-Hydroxypropyl methacrylamide, Poly(ethylene glycol) methacrylate, PLA methacrylate, and Poly(ethylene glycol) methacrylate.

The polymer material of the present invention demonstrates high oxygen permeability is suitably applied to contact lens for further protecting eyes from adverse environment.

### DETAILED DESCRIPTION OF THE PREFERRED EMBODIMENT

The present invention may be embodied in various forms and the details of the preferred embodiments of the present invention will be described in the subsequent content with reference to the accompanying drawings. The drawings (not to scale) show and depict only the preferred embodiments of the invention and shall not be considered as limitations to the scope of the present invention. Modifications of the shape of the present invention shall too be considered to be within the spirit of the present invention.

The hydrophilic and oxygen permeable polymer material according to the embodiment of the present invention has a structure presented by formula A-(B)_{b}-C, wherein A is alicyclic Isocyanate, B is a silicon-containing monomer modified by grafting as a repeating unit, b is an integer of 1-30, and , C is a first hydrophilic moisturing grafted monomer.

Specifically, (B)_{b} is preferably polydimethylsiloxane and has an average molecular weight less than or equal 5,000, and is in an amount of 20-60% based on the total weight of the hydrophilic and oxygen permeable polymer material. Further, the first hydrophilic moisturing grafted monomer is in an amount of 1-40% based on the total weight of the hydrophilic and oxygen permeable polymer material.

It is preferred that the first hydrophilic moisturing grafted monomer comprises at least one of Allyl alcohol, 2-Methyl-2-propen-1-ol, 2-Allylethyl alcohol, 2-(Dimethylamino)ethyl methacrylate, 2-(Dimethylamino)ethyl acrylate, 4-Penten-2-ol, N-[3-(Dimethylamino)propyl]methac Rylamide, Hydroxypropyl methacrylate, Poly(propylene glycol) methacrylate, 3-Methyl-2-buten-1-ol, rans,trans-2,4-Hexadien-1-ol, 2-Hydroxypropyl methacrylamide, Poly(ethylene glycol) methacrylate, PLA methacrylate, and Poly(ethylene glycol) methacrylate.

Furthermore, the chemical formula for the above first hydrophilic moisturing grafted monomer is summarized in Table 1.

TABLE 1
Allyl alcohol

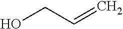

2-Methyl-2-propen-1-ol

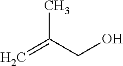

2-Allylethyl alcohol

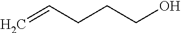

3-Methyl-2-buten-1-ol

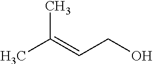

trans,trans-2,4-Hexadien-1-ol

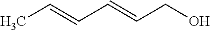

2-(Dimethylamino)ethyl
methacrylate

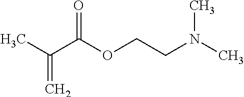

2-(Dimethylamino)
ethyl acrylate

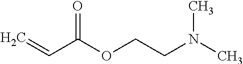

4-Penten-2-ol

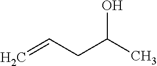

2-Hydroxypropyl
methacrylamide

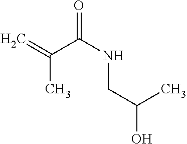

Poly(ethylene glycol)
methacrylate

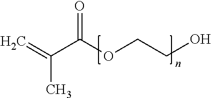

(Dimethylamino)propyl]
methacrylamide

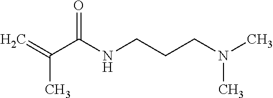

Hydroxypropyl methacrylate

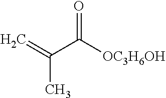

Poly(propylene glycol)
methacrylate

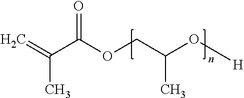

PLA methacrylate

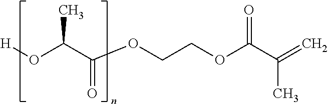

Poly(ethylene glycol)
methacrylate(PEGMA)

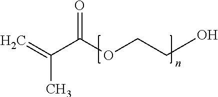

More specifically, the silicon-containing monomer comprises at least one of 3-methacryloxypropyl tris(trimethylsiloxy)silane, 3-acryloxypropyl tris(trimethylsiloxy)silane, 3-acrylamidopropyl tris(trimethylsiloxy)silane, 3-methacrylamidopropyl tris(trimethylsiloxy)silane, 3-vinyl carbamatepropyl tris(trimethylsiloxy)silane, and (3-methacryloxy-2-hydroxyprpoxy) propylbis (trimethylsiloxy)methylsilane.

The above silicon-containing monomer is further clearly expressed at Table 2 below.

TABLE 2
3-(Trimethoxysilyl)propylmethacrylate
H₂C═C(CH₃)CO₂(CH₂)₃Si(OCH₃)₃)

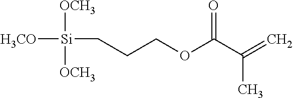 [SMILES: C=C(C)C(=O)OCCC[Si](OC)(OC)OC]

3-(Trimethoxysilyl)propyl acrylate
H₂C═CHCO₂(CH₂)₃Si(OCH₃)₃)

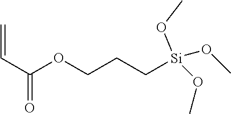

lamidopropyl tris(trimethylsiloxy)silane
C15H37NO4Si4

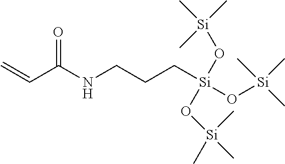 [SMILES: C=CC(=O)NCCC[Si](O[Si](C)(C)C)(O[Si](C)(C)C)O[Si](C)(C)C]

3-Methacrylamidopropyl
tris(trimethylsiloxy)silane
C₁₆H₃₉NO₄Si₄)

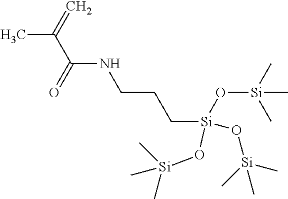 [SMILES: C=C(C)C(=O)NCCC[Si](O[Si](C)(C)C)(O[Si](C)(C)C)O[Si](C)(C)C]

3-Methacryloxypropylmethyl
dimethoxysilane
C₁₀H₂₀O₄Si

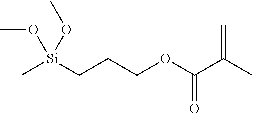

Triethoxyvinylsilane
H₂C═CHSi(OC₂H₅)₃)

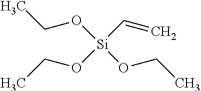

Preferably, the alicyclic isocyanate comprises 3-Isocyanatomethyl-3,5,5-trimethylcyclohexyl isocyanate (IPDI), which is represented by a formula:

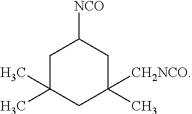

Specifically, IPDI has lower reactivity and vapor pressure than aromatic isocyanate, and includes two NCO groups, which have different chemical activity. The NCO group on the cyclohexane ring has stronger reactivity by 1.3-2.5 times than the other NCO group bonded with a methyl group, which suffers from retardation due to the cyclohexane ring and the methyl group. As a result, IPDI has the reaction rate with the hydroxyl group faster than HDI by 4-5 times.

The polyurethane resin made from IPDI demonstrates excellent optical stability and chemical endurance, and is suitably applied to high end polyurethane coating with optical and weather endurance, and elastomer with abrasion and hydrolysis endurance.

In addition, the hydrophilic and oxygen permeable polymer material further comprises a second hydrophilic moisturing grafted monomer, and the second hydrophilic moisturing grafted monomer preferably comprises at least one of Allyl alcohol, 2-Methyl-2-propen-1-ol, 2-Allylethyl alcohol, 2-(Dimethylamino)ethyl methacrylate, 2-(Dimethylamino)ethyl acrylate, 4-Penten-2-ol. N-[3-(Dimethylamino)propyl]methac rylamide, Hydroxypropyl methacrylate, Poly(propylene glycol) methacrylate, 3-Methyl-2-buten-1-ol, trans,trans-2,4-Hexadien-1-ol, N-3-Sulfopropyl-N,N-dimethyl ammonium)ethyl methacrylate, N,N-Dimethylacrylamide, Poly(ethylene glycol) methacrylate, 2-Hydroxypropyl methacrylamide, Poly(ethylene glycol) methacrylate, (Methacryloyloxy)ethyl]dimethylammoniolpropionate, 2-Hydroxyethyl methacrylate, PLA methacrylate, Phosphobetaine methacrylate, and Poly(ethylene glycol) methacrylate.

Furthermore, the chemical formula for the above first hydrophilic moisturing grafted monomer is summarized in Table 3.

TABLE 3
Allyl alcohol

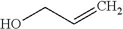

2-Methyl-2-propen-1-ol

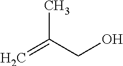

2-Allylethyl alcohol

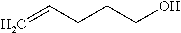

3-Methyl-2-buten-1-ol

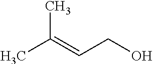

trans,trans-2,4-Hexadien-
1-ol

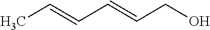

-3-Sulfopropyl-N,N-dimethyl
ammonium)ethyl
methacrylate, (SBMA)

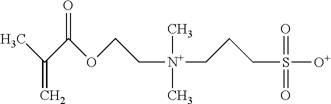 [SMILES: C=C(C)C(=O)OCC[N+](C)(C)CCCS(=O)(=O)[OH2+]]

N,N-Dimethylacrylamide

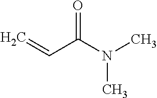

Poly(ethylene glycol)
methacrylate

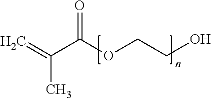

2-(Dimethylamino)ethyl
methacrylate

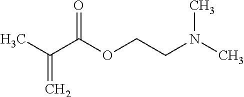

2-(Dimethylamino)ethyl
acrylate

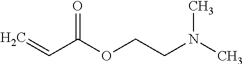

4-Penten-2-ol

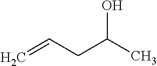

2-Hydroxypropyl
methacrylamide

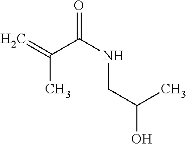

Poly(ethylene glycol)
methacrylate

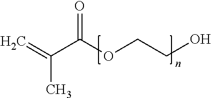

Methacryloyloxy)ethyl]
dimethylammonio]propionate
(CBMA)

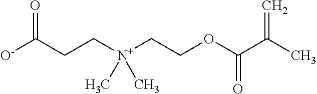 [SMILES: C=C(C)C(=O)OCC[N+](C)(C)CCC(=O)[O-]]

2-Hydroxyethyl
methacrylate

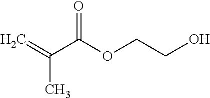

(Dimethylamino)propyl]
methacrylamide

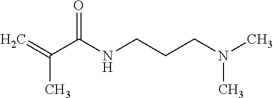

Hydroxypropyl
methacrylate

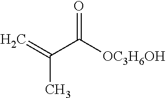

Hydroxypropyl
methacrylate

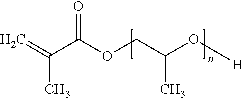

PLA methacrylate

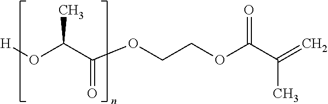

Phosphobetaine
methacrylate
(PBMA)

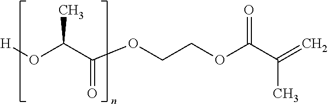

Poly(ethylene glycol)
methacrylate(PEGMA)

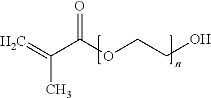

Polyvinylpyrrolidone cross-
linked

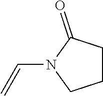

From the above mention, one aspect of the present invention is that the polymer material is highly hydrophilic and oxygen permeable, and furthermore, optical stability and chemical endurance are enhanced by IPDI, particularly, weather, abrasion and hydrolysis endurance. As a result, the polymer material of the present invention is suitably applied to high end polyurethane coating and elastomer.

Another aspect of the present invention is that when SBMA and CBMA listed at table 2 are processed by the second hydrophilic grafting, SBMA and CBMA as zwitterionic monomers can self-combine and self-assemble with balanced and charged material. For example, hyaluronic acid (HA) with negative electricity are easily aligned on the surface of the contact lens to increase the effect of moisturing and wetness.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A hydrophilic and oxygen permeable polymer material having a structure presented by formula A-(B)_{b}-C;
wherein A is alicyclic Isocyanate;
B is a silicon-containing monomer modified by grafting as a repeating unit;
b is an integer of 1-30;
(B)_{b} has an average molecular weight less than or equal 5,000, and in an amount of 20-60% based on the total weight of the hydrophilic and oxygen permeable polymer material;
C is a first hydrophilic moisturing grafted monomer and in an amount of 1-40% based on the total weight of the hydrophilic and oxygen permeable polymer material; and
the first hydrophilic moisturing grafted monomer comprises at least one of Allyl alcohol, 2-Methyl-2-propen-1-ol, 2-Allylethyl alcohol, 2-(Dimethylamino)ethyl methacrylate, 2-(Dimethylamino)ethyl acrylate, 4-Penten-2-ol, N-[3-(Dimethylamino)propyl]methac Rylamide, Hydroxypropyl methacrylate, Poly(propylene glycol) methacrylate, 3-Methyl-2-buten-1-ol, rans,trans-2,4-Hexadien-1-ol, 2-Hydroxypropyl methacrylamide, Poly(ethylene glycol) methacrylate, PLA methacrylate, and Poly(ethylene glycol) methacrylate.

2. The hydrophilic and oxygen permeable polymer material as claimed in claim 1, wherein the alicyclic Isocyanate comprises 3-Isocyanatomethyl-3,5,5-trimethylcyclohexyl isocyanate (IPDI) represented by a formula as:

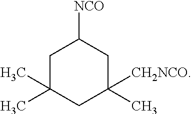

3. The hydrophilic and oxygen permeable polymer material as claimed in claim 1, wherein the silicon-containing monomer comprises at least one of 3-methacryloxypropyl tris(trimethylsiloxy)silane, 3-acryloxypropyl tris(trimethylsiloxy)silane, 3-acrylamidopropyl tris(trimethylsiloxy)silane, 3-methacrylamidopropyl tris(trimethylsiloxy)silane, 3-vinyl carbamatepropyl tris(trimethylsiloxy)silane, and (3-methacryloxy-2-hydroxyprpoxy) propylbis (trimethylsiloxy)methylsilane.

4. The hydrophilic and oxygen permeable polymer material as claimed in claim 1, further comprising a second hydrophilic moisturing grafted monomer, and the second hydrophilic moisturing grafted monomer comprising at least one of Allyl alcohol, 2-Methyl-2-propen-1-ol, 2-Allylethyl alcohol, 2-(Dimethylamino)ethyl methacrylate, 2-(Dimethylamino)ethyl acrylate, 4-Penten-2-ol. N[3-(Dimethylamino)propyl]methacrylamide, Hydroxypropyl methacrylate, Poly(propylene glycol) methacrylate, 3-Methyl-2-buten-1-ol, trans,trans-2,4-Hexadien-1-ol, N-3-Sulfopropyl-N,N-dimethyl ammonium)ethyl methacrylate, N,N-Dimethylacrylamide, Poly(ethylene glycol) methacrylate, 2-Hydroxypropyl methacrylamide, Poly(ethylene glycol) methacrylate, (Methacryloyloxy)ethyl]dimethylammoniol]propionate, 2-Hydroxyethyl methacrylate, PLA methacrylate, Phosphobetaine methacrylate, and Poly(ethylene glycol) methacrylate.

5. The hydrophilic and oxygen permeable polymer material as claimed in claim 1, wherein (B)_{b} is polydimethylsiloxane.
